(19) United States
(12) Patent Application Publication
(10) Pub. No.: US 2018/0154575 A1
(43) Pub. Date: Jun. 7, 2018

(54) METHODS AND APPARATUSES FOR COATING RELEASE LINERS

(71) Applicant: Loparex LLC, Cary, NC (US)

(72) Inventors: Edwin Ray Hortelano, Raleigh, NC (US); Lalit Singh Kochar, Naperville, IL (US); Michael W. Apperson, Raleigh, NC (US)

(73) Assignee: Loparex LLC

(21) Appl. No.: 15/833,472

(22) Filed: Dec. 6, 2017

Related U.S. Application Data
(60) Provisional application No. 62/430,591, filed on Dec. 6, 2016.

(51) Int. Cl. B29C 64/245; B29C 64/112; B29C 64/393; B29C 64/209; B33Y 10/00; B33Y 30/00; B33Y 50/02

(52) U.S. Cl. CPC B29C 64/245; B29C 64/112; B29C 64/393; B29K 2083/00; B33Y 10/00; B33Y 30/00; B33Y 50/02; B29C 64/209

(57) ABSTRACT

Methods and systems, and apparatuses, are disclosed relating to applying a coating to a release liner substrate comprising directing coating material to a release liner substrate material via at least one material dispensing head, and release liners made according to the methods, systems and apparatuses disclosed herein.

### RELATED APPLICATION

This application claims the benefit of priority under 35 USC § 119(e) of U.S. Provisional Patent Application No. 62/430,591, filed Dec. 6, 2016, the contents of which is incorporated herein by reference in its entirety.

### TECHNOLOGICAL FIELD

The present disclosure generally relates to the field of release liners. More particularly the present disclosure relates to manufacturing release liners using flexible substrates, for example, to prevent a sticky surface from prematurely adhering a substrate or having unwanted materials adhere to the unprotected adhesive. Still more particularly, the present disclosure relates to methods and apparatuses for applying a release liner coating on a flexible substrate, and forming release liners comprising at least one layer of silicone.

### BACKGROUND

Many adhesive-coated (e.g. tacky) surfaces employ release liners to protect one or more surfaces of a film or paper coated with an adhesive to prevent one or both tacky surfaces from prematurely adhering before affecting a predetermined end use. The release liners typically comprise a substrate material layer, and often comprise an additional layer or layers on the substrate material layer. The composition of the substrate being protected, as well as the desired end use of the film or coating (and any layers positioned proximate to the substrate material layer) often depend on the composition of the selected adhesive. Useful substrates include, without limitation, paper, polymer coated paper, polymer films, etc. Often a silicone layer is applied to the substrate material layer.

Known processes for applying layers, such as silicone coating layers, on release liner substrate materials include offset gravure, direct gravure and Mayer rod processes.

### BRIEF SUMMARY

According to one aspect of the present disclosure a method for applying a coating layer to a release liner substrate material is disclosed comprising: orienting a release liner substrate material to receive a coating material; orienting at least one material dispensing head in a predetermined orientation proximate to the release liner substrate material, said material dispensing head in communication with a coating material supply; delivering a predetermined amount of coating material from the coating material supply to the material dispensing head; and delivering a predetermined amount of coating material from the material dispensing head to the release liner substrate material.

In a further aspect, the material dispensing head comprises at least one of an ink jet printing head, a 3-D printing head, a laser printing head, a thermal printing head, a digital printing head, etc.

In another aspect, the material dispensing head deposits to the release liner substrate material a layer of coating material to a layer thickness ranging from about 1 nm to about 1 mm or more.

In another aspect, the coating material comprises a silicone polymer or a silicone-containing polymer. The coating material may also be other silicone-free or fluorinated polymers that create a release effect.

In yet another aspect, a plurality of material dispensing heads is oriented in a predetermined orientation proximate to the release liner substrate material, with the material dispensing heads configured to release a predetermined amount of coating material to the release liner substrate material.

In another aspect, a plurality of material dispensing heads are oriented in a predetermined orientation proximate to the release liner substrate material, said material dispensing heads configured to release predetermined amount of a predetermined cured coating material component.

In a further aspect, a plurality of material dispensing heads are oriented in a predetermined orientation proximate to the release liner substrate material, said material dispensing heads configured to release predetermined amount of a predetermined uncured coating material component.

In still another aspect, a method for applying a coating layer to a release liner substrate material is disclosed comprising: orienting a release liner substrate material to receive a coating material; orienting at least one material dispensing head in a predetermined orientation proximate to the release liner substrate material, said material dispensing head in communication with a coating material supply/reservoir/tank; delivering a predetermined amount of coating material from the coating material supply to the material dispensing head; and delivering a predetermined amount of coating material from the material dispensing head to the release liner substrate material, further comprising a means for controlling at least one of: material dispensing head, the amount of coating material delivered from the coating material supply to the material dispensing head, the amount of coating material delivered from the material dispensing head to the release liner substrate material, and the movement of the substrate material and the movement of the material dispensing head.

In a still further aspect, a method is contemplated for providing a means for controlling at least one of: the material dispensing head; an amount of coating material component delivered to the material dispensing head; an amount of coating material component delivered from the material dispensing head to the release liner substrate material; and movement of the release liner substrate material.

In another aspect, the means for controlling at least one of: the material dispensing head, the amount of coating material delivered from the coating material supply to the material dispensing head, the amount of coating material delivered from the material dispensing head to the release liner substrate material, and the movement of the substrate material and the movement of the material dispensing head comprises a controller in communication with sensors, with said controller in communication with a computer.

In yet another aspect, in the step of delivering a predetermined amount of coating material from the material dispensing head to the release liner substrate material, the predetermined amount of coating material is delivered to the release liner substrate material substrate according to a programmed digital pattern.

In a further aspect, the present disclosure comprises a production line for producing a release liner comprising: a release liner substrate material, at least one material dispensing head oriented in a predetermined orientation proximate to the release liner substrate material, and a coating material supply in communication with the material dispensing head.

In another aspect, the material dispensing head is configured to deliver a predetermined amount of coating material or coating material component from the coating material supply or the coating material component supply to the material dispensing head.

In yet another aspect, the material dispensing head is configured to deliver a predetermined amount of coating material or coating material component from the coating material dispensing head to the release liner substrate material.

In a further aspect, the material dispensing head comprises at least one of an ink jet printing head, a 3-D printing head, a laser printing head, a thermal printing head, and a digital printing head.

In yet another aspect, the material dispensing head deposits to the release liner substrate material a layer of material to a layer thickness ranging from greater than 0 microns to 5 microns, optionally in the range of 0.5 microns to 2.5 microns.

In a further aspect, the coating material comprises a silicone-containing polymer or silicone containing material.

In another aspect, a plurality of material dispensing heads is oriented in a predetermined orientation proximate to the release liner substrate material.

In another aspect, the line further comprises a means for controlling at least one of: the material dispensing head, the amount of coating material delivered from the coating material supply to the material dispensing head, the amount of coating material delivered from the material dispensing head to the release liner substrate material, and the movement of the substrate material and the movement of the material dispensing head.

In a further aspect, the means for controlling at least one of: the material dispensing head, the amount of coating material delivered from the coating material supply to the material dispensing head, the amount of coating material delivered from the material dispensing head to the release liner substrate material, and the movement of the substrate material and the movement of the material dispensing head comprises a controller in communication with sensors, with the controller in communication with a computer.

In another aspect, the coating material comprises separate coating material component supplies, with each coating material component supply housed separately along the line.

In a still further aspect, the coating material components optionally comprise one or more of: a pigment, a binder, a release additive, a catalyst, a primer; a curing agent; a plasticizer; a pH control compound; and an additive, alone or in combination.

In another aspect, the coating material component supply is in communication with one or more of the plurality of material dispensing heads, said material dispensing heads oriented in a predetermined orientation proximate to the release liner substrate material, said material dispensing heads configured to release predetermined amount of a predetermined cured coating material component.

In yet another aspect, the coating material component supply is in communication with one or more of the plurality of material dispensing heads, said material dispensing heads oriented in a predetermined orientation proximate to the release liner substrate material, said material dispensing heads configured to release predetermined amount of a predetermined uncured coating material component.

In a still further aspect, the predetermined amount of coating material is delivered to the release liner substrate material according to a programmed digital pattern.

In a further aspect, the predetermined amount of coating material delivered to the release liner substrate material displays predetermined variable characteristics at predetermined regions of the release liner substrate material.

In yet another aspect, the variable characteristics comprise color, tinting, reflectivity, thickness, opaqueness, adherence, tack, anchorage of the coating to a substrate, extractables from the cured coating, coat weight, the force needed to peel a defined adhesive from the release liner at a specified angle and speed.

A further aspect comprises a release liner made according to the method of orienting a release liner substrate material to receive a coating material; orienting at least one material dispensing head in a predetermined orientation proximate to the release liner substrate material, said material dispensing head in communication with a coating material supply; delivering a predetermined amount of coating material from the coating material supply to the material dispensing head; and delivering a predetermined amount of coating material from the material dispensing head to the release liner substrate material.

A further aspect is directed to an object comprising a film having features imparted to the film from a release liner made according to the method of orienting a release liner substrate material to receive a coating material; orienting at least one material dispensing head in a predetermined orientation proximate to the release liner substrate material, said material dispensing head in communication with a coating material supply; delivering a predetermined amount of coating material from the coating material supply to the material dispensing head; and delivering a predetermined amount of coating material from the material dispensing head to the release liner substrate material.

In a further aspect, the object is a stationary object.

In another aspect, the object is a vehicle.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a release liner production line; and,

FIG. 2 is a flowchart of a method of coating a release liner.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Aspects of the present disclosure are directed to the use of material deposit technologies including, without limitation, technologies that are the same or similar in function as printing technologies, for the purpose of depositing or otherwise applying coatings and films to a release liner substrate surface. Contemplated deposit amounts include, without limitation, deposits at amounts of from about one or more nanometers to several microns or more, for example to create a dry coating material layer thickness greater than 0 microns to 5 microns, or 0.5 microns to 2.5 microns. Contemplated technologies include, without limitation, ink jet printing technology, 3-D printing technology, laser printing technology, thermal printing technology, digital printing technology, etc. For the purpose of this application, the term “material deposition technology” encompasses and is an equivalent term for ink jet printing technology, 3-D printing technology, laser printing technology, thermal printing technology, digital printing technology etc., and the terms may be used interchangeably. Similarly, “material dispensing heads” encompasses and is an equivalent term for ink jet printing heads, 3-D printing heads, laser printing heads, thermal printing heads, digital printing heads etc., and the terms may be used interchangeably. Further, for the purposes of this application, the terms “dispensing head” and dispersing head” are equivalent terms and can be used interchangeably. In other words, for the purposes of this application, the material dispensing heads are understood to not only dispense material, but also disperse the material.

By replacing various current means of applying coatings and films to release liner substrate materials, (such as various gravure methods including, without limitation, offset gravure, direct gravure, Mayer rod processes, etc.), with material dispensing head technology, significant processing flexibility and resulting flexibility with respect to the variety of characteristics of release liners can be the significantly improved and expanded.

In addition, according to aspects of the present disclosure, applying coatings and films using ink jet printing technology, including material dispensing heads, affords significant coating processing advantages and economies relative to the overall processes used to make coated release liners.

According to known technology, coating processes limit the ability to quickly or easily change many variables of the silicone coating layer including, without limitation, the width of the coating layer, the thickness of the coating layer, the features of the coating layer; the patterns of the coating layer, whether the coating layer is substantially continuous or discontinuous, etc. That is, it is not possible to change release patterns (release differences) without changing coat weight thicknesses or without changing the coating formulations that are to be applied to a release liner substrate material.

By contrast, according to aspects of the present disclosure, coating formulation changes can be made substantially instantaneously by changing the characteristics of the coating material supply that is delivered to the material dispensing head(s). In this way, according to aspects of the present disclosure, changes to the amounts of coating material supplied to the material dispensing head(s) from the coating material supply can deliver any desired and predetermined coat weight, without necessitating a change of coating material, or a change in the machinery and components (e.g. rollers) of the types previously used in gravure processes.

Known processes for applying layers, including, for example, silicone layers to release liner substrate materials, require significant down time to change components in the production line or to change the composition of the materials to be applied as layers on the substrate material. Such components, including, without limitation, rollers, supply lines, hoses, etc. control the features of the film layers that are to be applied to a release liner substrate material. When a desired film layer (e.g. silicone film layer) having different or differing characteristics is desired, equipment (e.g. equipment components) must be changed, as well as the compound or composition (i.e. coating material) being applied as a film layer on the substrate material. Such a change of equipment, component parts, and coating material is time consuming and results in a significant amount of processing down time.

According to further aspects of the present disclosure, by controlling the operation of the printer head(s) during coating processes (in concert with or separately from controlling/interrupting the supply of coating material to the material dispensing head(s) from the coating material supply), changes in the resulting deposition of the coating material onto the release liner substrate material can be made “on the fly” to affect, for example, a predetermined pattern in a coating that may be substantially continuous or even a pattern that is discontinuous, if desired. This flexibility is in strong contrast to the patterns that can now be transferred to a release liner substrate material using and having to change, for example, rollers having a predetermined pattern in known gravure and other coating processes. This ability to obviate the cost and disruption of needing to shut down production, or add process steps while changes are made to equipment on the coating line facilitates uninterrupted production, and contributes to a significant improvement in processing efficiency and reduced cost.

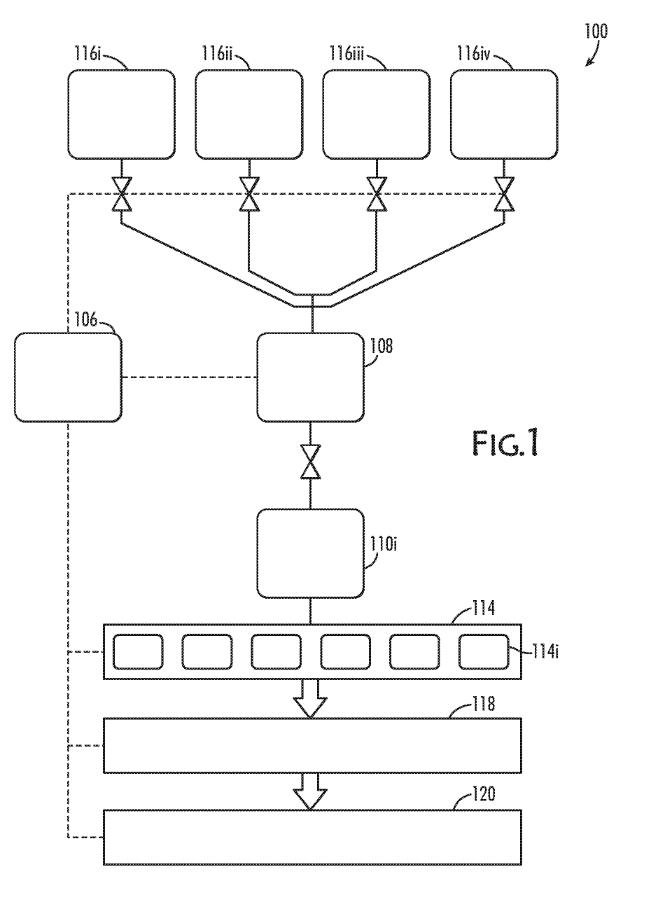

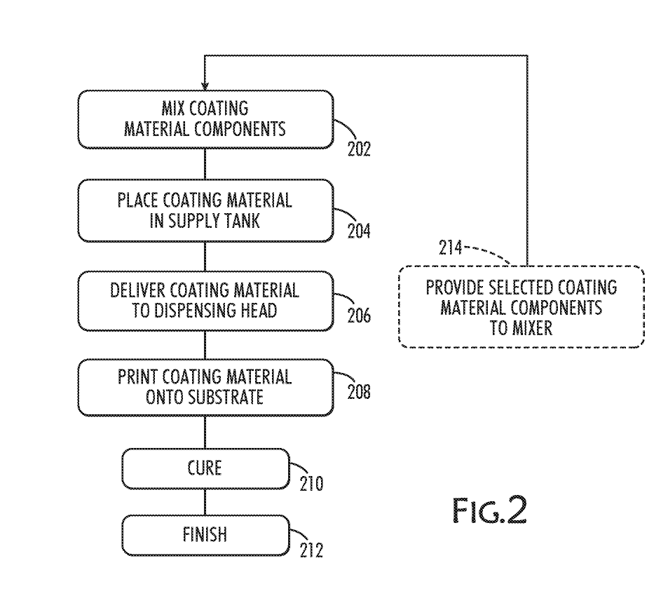

FIG. 1 is a block diagram of a release liner production line 100, in accordance with exemplary embodiments of the invention. For the sake of brevity, the production line 100 of FIG. 1 will be described in conjunction with FIG. 2, which is a flowchart of a method 200 of coating a release liner using the production line 100, according to some exemplary embodiments of the invention. In an aspect, the production line 100 includes a digital printer 102 which places at least one coating material tank/supply/reservoir 110i, . . . n in fluid communication with a print head cartridge 114 (which includes at least one “material dispensing head” 114i for actually dispensing the coating material onto a substrate 104). The substrate 104 is not an element of the production line 100, in an aspect of the invention, and is shown in FIG. 1 for context. In some embodiments, at least one mixer 108 is used for mixing/preparing (202) a coating material 116i, . . . , n according to a desired formulation, before placing (204) a mixed coating material component into at least one coating material supply 110i. Examples of coating material components include at least one polymer, at least one cross-linking agent, at least one controlled release additive and at least one solvent. The coating material is delivered (206) to the print head cartridge 114 for printing (208) onto the substrate 104. The substrate 104 is often web-based, the web handling equipment is not shown in FIG. 1.

In some embodiments, and as described elsewhere herein, a plurality of coating material components may be selectively placed (214) in a multi-chamber apparatus (having separate chambers for different coating material components) and/or the mixer 108 for selectably delivering (206) them to the print head cartridge 114, for example through a multi-chambered container 116i, . . . n and/or through a plurality of separate tubes. Optionally, a plurality of coating material components are combined/mixed prior to their printing (208) onto the substrate 104. It should be understood that because each coating material component is stored separately, the amount of each component delivered to the mixer 108, and ultimately the substrate 104, can be varied “on the fly” to change the coating material formulation made in the mixer 108, for example at least partially by a software-programmed controller 106. In addition, by not creating the coating material formulation until actually needed and on demand, the coating process ultimately saves on coating material component usage.

Once printing (208) of the coating material on the substrate 104 is complete, the coating material is cured (210), for example in an oven 118, to allow the coating material layer on the substrate 104 to stabilize. In some embodiments, the cured (210) substrate 104 is finished (212), for example by a slitting apparatus 120, for commercial sale and/or use.

In some embodiments, coating material includes a silicone-based component, a silicon-free component, a fluorinated material and/or involves a material subjected to thermal curing, catalyzed with Pt, Rh, Sn, etc., radiation curing in inerted or non-inerted systems, solvent-free, solvent-borne, or water-borne emulsions.

In still further aspects, the presence of a plurality of material dispensing heads, or even a bank or banks of material dispensing heads that can be automatically controlled by the software-programmed controller 106 or manually controlled to receive and deliver different amounts of coating material, further contributes to the flexibility of creating a predetermined effect on a coating or film that is to be deposited on a release liner substrate material. Such desired, predetermined effect can include, without limitation, varied thicknesses of coating material as well as the presence or absence of the coating material, thereby enabling the creation of predetermined patterns that may desirably repeat or not repeat, and that may be applied to a substrate surface in any regular or irregular pattern as desired.

In addition, according to further aspects, completely separate coating formulations may be directed to one or more material dispensing heads. In this way, the characteristics of the deposited coating onto the release liner substrate can be widely varied in a predictable and predetermined fashion to deliver coatings that can cure at varied and predetermined rates, or that can be selectively built up to form any orientation including, without limitation, thicknesses, widths, patterns, etc.

Material dispensing heads can be dedicated to one or even more than one coating supply as desired. If material dispensing heads are to be dedicated to a particular coating supply, it is understood that, according to aspects of the present disclosure, such supply of a coating material to a release liner surface may be interrupted according to a software program to effect a particular result or pattern on a release liner substrate surface. However, the present disclosure further contemplates the ability to also deliver a plurality of coating material supply lines to an individual material dispensing head. According to a desired program or protocol, coatings having different composition may be directed from discrete coating supplies/sources through suitable lines/hoses to a single material dispensing head as desired to deliver a coating having desired characteristics and patterns in varied regions of the coated substrate material.

As a result, the maintenance and cleaning of such equipment as disclosed presently is greatly reduced as compared to the maintenance and cleaning required in known gravure systems. In such known systems, the rollers, supply lines and other components must be cleansed with solvents that must be supplied and collected and later disposed of. The accumulation of waste material from the cleaning and maintenance of presently known coated release liner manufacture is substantial and costly. While health and regulation standards may require the use of less toxic solvents such as, for example, methyl ethyl ketone, heptane, acetone, isopropyl alcohol, the collection, storage, and disposal of such solvents significantly adds to the cost and complexity of known coating processes.

According to known release line coating processes, coating material components comprise base materials along with curing agents, initiators, inhibitors, etc. that must be mixed to obtain the desired resultant coating material. This need to mix components often creates coating materials having a defined and limited shelf life, or pot life, within which the coating material must be used. As would be readily understood by one skilled in the field of films and coating, material shelf lives limit process capabilities and create further waste once a coating material begins to cure to an undesirable degree prior to the coating's end use.

Aspects of the present disclosure contemplate directing various coating components including, without limitation, curing agents, initiators, inhibitors, release additives etc. that are mixed to obtain the desired resultant coating material to various material dispensing heads, plurality of material dispensing heads or areas of material dispensing head banks to achieve desired cure rates or other desired characteristics of the coating material without limiting considerations of time and/or temperature. In other words, according to aspects of the present disclosure, rather than mixing batches of coating materials (that may have finite shelf-life or pot-life) in advance of their application to a substrate surface, use of the contemplated technology, methods, system and apparatuses allow various coating material components (e.g. binders, pigments, primers, catalysts, curing agents, release additives, plasticizers, pH controls, and any other additives etc.) to be supplied from a source to a material dispensing head separately or together and via separate lines or the same line as desired. This significantly increased flexibility allows a user to select and individualize coating material component and amounts of such components “on the fly” to perform and complete even a single order or job. In this way, aspects of the present disclosure contemplate altering a coating composition itself, as well as a coating composition deposition pattern or thickness (for, example, by selectively and even continuously altering the ratio of coating components, etc.) over predetermined and preselected regions of a single substrate for a single order or job. As a result, if a particular characteristic is desired in a specific region of a substrate to be coated, the delivery of coating material may be programmed to alter during the course of the coating run. Such coating characteristics include, without limitation, color, tinting, reflectivity, thickness, adherence, tack, anchorage of the coating material to a substrate, extractables from the cured coating material, the force needed to peel a defined adhesive from the release liner at a specified angle and speed etc.

Still further, the known coating processes for introducing coatings, including, without limitation, silicone coatings, onto release liner substrates may include the presence of various inhibitors with the silicone to control rates of curing. Therefore, as stated elsewhere herein, aspects of the presently disclosed processes contemplate the ability to direct different coating formulations, different coating formulation amounts, or variable ratios of coating components and formulation ratios from a component source/supply through different material dispensing heads, or material dispensing head rows, or banks of material dispensing heads, to help to achieve coating material shelf lives that may approximate that of the unmixed components.

Again, since various supply lines and printer heads may be dedicated to certain materials and coating components, the need to flush or clean such lines would be greatly reduced or even obviated, thus realizing tremendous time and processing savings, thereby reducing processing costs.

The disclosed processes offer further benefits such as the ability to perform short runs or other small runs of custom orders with specialized requirements by adjusting coating material components more easily via the multiplicity and variety afforded the present processes via the use of any desired number of material dispensing heads, material dispensing head rows, or material dispensing head banks that can deliver the customized coating materials and coating material components.

As mentioned above, the previous constraints of web widths are now limited only by the dimension of the substrate material, as the area of coating can be infinitely varied (widened, narrowed, etc.) by varying the dimension of the material dispensing head banks, etc.

Therefore, according to aspects of the present disclosure, processing lead times can be shortened, prototyping and scale up are more easily facilitated, coat weight and other deposit characteristics can be changed “on the fly”, including the creation of limitless patterns, etc, and the entire process can be controlled digitally by developed software programs designed to take advantage of the disclosed systems' flexibilities.

Characteristics of the deposited coating include patterns that can assist with fluid (including air) egress from films. Further, according to the present disclosure, desired characteristics such as predetermined coloration and/or tinting can be more easily conducted by altering coating compositions gradually or dramatically over desired sections of a single finished product.

The variations and alternatives of the present disclosure relate to the manufacture and use of release liners for coatings and films of any dimension that can be applied to both or either of stationary and mobile objects. Stationary objects can be any fixed object and include, without limitations buildings, signs, ramp garages, etc. Mobile objects include, without limitation, vehicles including manned and unmanned terrestrial vehicles, waterborne vehicles, and aircraft and spacecraft.

Implementation of the methods and/or systems of embodiments of the invention can involve performing or completing selected tasks manually, automatically, or a combination thereof. Moreover, according to actual instrumentation and equipment of embodiments of the methods and/or systems of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

While the various variations and alternatives of the present disclosure have been illustrated and described, it will be appreciated that changes and substitutions can be made therein without departing from the spirit and scope of the disclosure. It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Accordingly, the scope of the disclosure should only be limited by the accompanying claims and equivalents thereof.

When introducing elements of the present disclosure or exemplary aspects or embodiment(s) thereof, the articles “a,” “an,” “the” and “said” are intended to mean that there are one or more of the elements. The terms “comprising,” “including” and “having” are intended to be inclusive and mean that there may be additional elements other than the listed elements. Although this disclosure has been described with respect to specific embodiments, the details of these embodiments are not to be construed as limitations.

Various embodiments and aspects of the present invention as delineated hereinabove and as claimed in the claims section below find experimental and/or calculated support in the following examples.

### EXAMPLES

Reference is now made to the following examples and tables, which together with the above descriptions illustrate some embodiments of the invention in a non-limiting fashion. In some examples, testing data is provided which includes silicone coat weight measurements taken via x-ray fluorescence and/or release force testing. In some examples, the coat weights applied and/or measured are lower than would be applied using conventional coating methods such as offset gravure, Mayer rod or direct gravure. It should be understood that, in accordance with the inventive embodiments described herein, the coat weight can be adjusted “on the fly” by increasing the drop size during coating application by inkjet printing head. It should be understood that the specific formulations described are by way of example only and that ranges of coating material components, differing formulations, number of tanks, processing parameters and/or curing procedures could be used.

### Example 1

Processing Parameters (Typical Processing Parameters for Inks and Coatings that can be Jetted Using an Inkjet Coating Head)
a. Viscosity: Approximately 10±2 cps at the application temperature (lower/higher viscosity liquids are optional, for example as some print heads can handle up to 30-40 cps).
   i. Brookfield DV-II viscometer, #18 spindle, 100 rpm @room temperature (approximately 25° C.). 8 g of liquid is desirable for viscosity measurement.
b. Particle size, less than 1μ, typically around 0.3μ
c. Silicone polymers <100 k Dalton MW. Optionally between 20-50 k Dalton MW.
d. Can jet lower surface energy materials. Optional surface tension: 30-32 dyn/cm. Optionally can use fluids in 18-22 dyn/cm range.
e. Open time for coating—drying out in nozzle, continuous drop (no build up)
f. Coating Thickness: About 8 μm wet to get 1 μm dry (however, it should be understood that the wet thickness may vary depending on the % solids used for the formulation). DMP print head has heating option.
g. Can perform to 200-600 ft/min at 8 μm wet thickness depending on the print head selection.

Formula

For a one-tank coating (solvent diluted solventless platinum coating on a 3.2 mil bleached Super Calendered Kraft (“SCK”) paper), using a one-tank system (all ingredients mixed together and then fed in a print head cartridge, for example a Dimatix® print cartridge from Fujifilm®, for applying the coating to the substrate).

TABLE 1
One-tank Coating Formulation
One-Tank Formulation
100 g Batch

| Material | Amount |
|---|---|
| H Heptane | 74.15 |
| Silcolease 8560 | 23.41 |
| XL-321 Crosslinker | 0.77 |
| Cata 200-PEX | 1.67 |
| Total (g) | 100 |
| % Solids | 25.85% |
| SiH/Vinyl | 1.7 |
| Platinum (ppm) | 100 |

Where the Silcolease® 8560 used is a polydimethylsiloxane, vinyl end-blocked substance available from Elkem® Silicones (Formerly Bluestar) as of the filing date of this application.

Where the XL-321 Crosslinker is a methyl hydrogen polysiloxane cross linking agent available from Elkem® Silicones (Formerly Bluestar) as of the filing date of this application.

Where the Cata 200-PEX is platinum catalyst/antimist additive available from Elkem® Silicones (Formerly Bluestar) as of the filing date of this application.

Cure Condition

350° F. (177° C.) for 60 s.

Results

TABLE 2
Theoretical and Measured Drop Size Performance at Different Grey Levels
One-Tank Formulation 25.85% solids

| | | | | | | | Measured |
|---|---|---|---|---|---|---|---|
| | | | | | | | Coat weight |
| Drop | | Process | Grey | Wet Coat | Theoretical | Release | (gsm) based |
| volume | Printhead | Direction | Level | Weight | coat | Force Testing | on X-ray |
| (pL) | DPI | DPI | (%) | (gsm) | Weight (gsm) | Values (g/in) | fluorescence |
| 10 | 317.50 | 317.50 | 10% | 0.16 | 0.04 | N/A* | 0.0179 |
| 10 | 317.50 | 317.50 | 30% | 0.47 | 0.12 | N/A* | 0.0514 |
| 10 | 317.50 | 317.50 | 50% | 0.78 | 0.20 | 362.5 | 0.1108 |
| 10 | 317.50 | 317.50 | 70% | 1.09 | 0.28 | 226.5 | 0.1310 |
| 10 | 317.50 | 317.50 | 100% | 1.56 | 0.40 | 96.9 | 0.2155 |

*Substrate delaminated during release testing

### Example 2

Processing Parameters (Typical Processing Parameters for Inks and Coatings that can be Jetted Using an Inkjet Coating Head)
a. Viscosity: Approximately 10±2 cps at the application temperature (lower/higher viscosity liquids are optional, for example as some print heads can handle up to 30-40 cps).
   i. Brookfield DV-II viscometer, #18 spindle, 100 rpm @room temperature (approximately 25° C.). 8 g of liquid is desirable for viscosity measurement.
b. Particle size, less than 1μ, typically around 0.3μ
c. Silicone polymers <100 k Dalton MW. Optionally between 20-50 k Dalton MW.
d. Can jet lower surface energy materials. Optional surface tension: 30-32 dyn/cm. Optionally can use fluids in 18-22 dyn/cm range.
e. Open time for coating—drying out in nozzle, continuous drop (no build up)
f. Coating Thickness: About 8 μm wet to get 1 μm dry (however, it should be understood that the wet thickness may vary depending on the % solids used for the formulation). DMP print head has heating option.
g. Can perform to 200-600 ft/min at 8 μm wet thickness depending on the print head selection.

Formula

Two-tank coating (solvent platinum silicone coating on a 74# polycoated kraft paper) using a two tank system. The formulation was broken in two parts: Part A, a catalyst tank; and, Part B, a silicone tank. The coating from each tank was loaded in two separate cavities of a two barrel plunger. A static mix head was attached at end of the two barrel syringe for mixing the coatings from the two cavities to feed a print head cartridge, for example a Dimatix® print cartridge from Fujifilm®, for applying the coating to the substrate.

TABLE 3
Two-Tank Coating Formulation
Two-Tank Formulation

| Material | Amount |
|---|---|
| Tank 1 (catalyst tank) | |
| Heptane | 98.28 |
| Catalyst - OL | 1.72 |
| Total (g) | 100 |
| Tank 2 (silicone tank) | |
| Heptane | 27.52 |
| Dehesive 910 | 41.17 |
| CRA-17 | 27.42 |
| Crosslinker V24 | 3.74 |
| HF86 or CFA 100 | 0.15 |
| Total (g) | 100 |
| % Solids | 41% |
| SiH/Vinyl | 1.83 |
| Platinum (ppm) | 187 |

Where the Catalyst—OL is a platinum catalyst available from Wacker Silicone Corporation as of the filing date of this application.

Where the Dehesive 910 is a polydimethylsiloxane, vinyl end-blocked substance available from Wacker Silicone Corporation as of the filing date of this application.

Where the CRA-17 is a high molecular wt silicone resin with vinyl group available from Wacker Silicone Corporation as of the filing date of this application.

Where the Crosslinker V24 is a methyl hydrogen polysiloxane cross linking agent available from Wacker Silicone Corporation as of the filing date of this application.

Where the HF86 or CFA 100 is an anchorage additive available from Wacker Silicone Corporation as of the filing date of this application.

Cure Condition

260 F (127 C) for 60 s.

Results

TABLE 4
Theoretical and Measured Drop Size Performance at Different Grey Levels
Two-Tank Formulation 41% solids

| | | | | | | | Measured |
|---|---|---|---|---|---|---|---|
| | | | | | | | Coat weight |
| Drop | | Process | Grey | Wet Coat | Theoretical | Release | (gsm) based |
| volume | Printhead | Direction | Level | Weight | coat | Force Testing | on X-ray |
| (pL) | DPI | DPI | (%) | (gsm) | Weight (gsm) | Values (g/in) | fluorescence |
| 10 | 317.50 | 317.50 | 10% | 0.16 | 0.06 | N/A* | 0.0596 |
| 10 | 317.50 | 317.50 | 30% | 0.47 | 0.19 | N/A* | 0.1518 |
| 10 | 317.50 | 317.50 | 50% | 0.78 | 0.32 | 495.0 | 0.2576 |
| 10 | 317.50 | 317.50 | 70% | 1.09 | 0.45 | 398.5 | 0.3680 |
| 10 | 317.50 | 317.50 | 100% | 1.56 | 0.64 | 308.5 | 0.5498 |

*Substrate delaminated during release testing

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for applying a coating layer to a release liner substrate material comprising:
orienting a release liner substrate material to receive a coating material;
orienting at least one material dispensing head in a predetermined orientation proximate to the release liner substrate material, said material dispensing head in communication with a coating material supply;
delivering a predetermined amount of coating material from the coating material supply to the material dispensing head; and
delivering a predetermined amount of coating material from the material dispensing head to the release liner substrate material.

2. The method of claim 1, wherein the material dispensing head comprises at least one of an ink jet printing head, a 3-D printing head, a laser printing head, a thermal printing head, and a digital printing head.

3. The method of claim 1, wherein the material dispensing head deposits to the release liner substrate material a layer of coating material to a layer thickness ranging from greater than 0 microns to 5 microns.

4. The method of claim 1, wherein the material dispensing head deposits to the release liner substrate material a layer of coating material to a layer thickness ranging from 0.5 microns to 2.5 microns.

5. The method of claim 1, wherein the coating material comprises at least one of a silicone-containing polymer, a non-silicone material, and a fluorinated material.

6. The method of claim 1, wherein a plurality of material dispensing heads are oriented in a predetermined orientation proximate to the release liner substrate material, said material dispensing heads configured to release predetermined amount of a coating material.

7. The method of claim 1, wherein a plurality of material dispensing heads are oriented in a predetermined orientation proximate to the release liner substrate material, said material dispensing heads configured to release predetermined amount of a predetermined cured coating material component.

8. The method of claim 1, wherein a plurality of material dispensing heads are oriented in a predetermined orientation proximate to the release liner substrate material, said material dispensing heads configured to release predetermined amount of a predetermined uncured coating material component.

9. The method of claim 1, further providing a means for controlling at least one of: the material dispensing head; an amount of coating material delivered to the material dispensing head; an amount of coating material delivered from the material dispensing head to the release liner substrate material; and movement of the substrate material.

10. The method of claim 1, further providing a means for controlling at least one of: the material dispensing head; an amount of coating material component delivered to the material dispensing head; an amount of coating material component delivered from the material dispensing head to the release liner substrate material; and movement of the release liner substrate material.

11. The method of claim 9, wherein the means for controlling at least one of: the material dispensing head; the amount of coating material delivered to the material dispensing head; the amount of coating material delivered from the material dispensing head to the release liner substrate material; and movement of the substrate material comprises a controller in communication with sensors, with said controller in communication with a computer.

12. The method of claim 11, wherein, in the step of delivering a predetermined amount of coating material from the material dispensing head to the release liner substrate material, the predetermined amount of coating material is delivered to the release liner substrate material substrate according to a programmed digital pattern.

13. A production line for producing a release liner including a substrate material comprising:
at least one material dispensing head orientable in a predetermined orientation proximate to the release liner substrate material; and
at least one coating material supply in communication with said material dispensing head;
wherein said material dispensing head is configured to deliver a predetermined amount of coating material from the coating material supply to the material dispensing head; and
wherein said material dispensing head is configured to deliver a predetermined amount of coating material from the material dispensing head to the release liner substrate material.

14. The production line of claim 13, wherein the material dispensing head comprises at least one of an ink jet printing head, a 3-D printing head, a laser printing head, a thermal printing head, and a digital printing head.

15. The production line of claim 13, wherein the material dispensing head deposits to the release liner substrate material a layer of material to a layer thickness ranging from greater than 0 microns to 5 microns dry.

16. The production line of claim 13, wherein the material dispensing head deposits to the release liner substrate material a layer of material to a layer thickness ranging from 0.5 microns to 2.5 microns dry.

17. The production line of claim 13, wherein, wherein the coating material comprises a silicone-containing material.

18. The production line of claim 13, wherein a plurality of material dispensing heads is oriented in a predetermined orientation proximate to the release liner substrate material.

19. The production line of claim 13, further comprising a means for controlling at least one of: the material dispensing head; an amount of coating material delivered to the material dispensing head; an amount of coating material delivered from the material dispensing head to the release liner substrate material; and movement of the substrate material.

20. The production line of claim 19, wherein the means for controlling at least one of: the material dispensing head; an amount of coating material delivered to the material dispensing head; an amount of coating material delivered from the material dispensing head to the release liner substrate material; and movement of the substrate material comprises a controller in communication with sensors, said controller in communication with a computer.

21. The production line of claim 13, wherein the coating material comprises separate coating material component supplies, with each coating material component supply housed separately along the production line.

22. The production line of claim 21, wherein the coating material components comprise at least one of a pigment, a binders, a release additive, a catalysts, a primer, a curing agent, a plasticizer, a pH control compound, and, an additive.

23. The production line of claim 21, wherein the coating material component supply is in communication with one or more of the plurality of material dispensing heads, said material dispensing heads oriented in a predetermined orientation proximate to the release liner substrate material, said material dispensing heads configured to release predetermined amount of a predetermined cured coating material component.

24. The production line of claim 21, wherein the coating material component supply is in communication with one or more of the plurality of material dispensing heads, said material dispensing heads oriented in a predetermined orientation proximate to the release liner substrate material, said material dispensing heads configured to release predetermined amount of a predetermined uncured coating material component.

25. The production line of claim 13, wherein, the predetermined amount of coating material is delivered to the release liner substrate material according to a programmed digital pattern.

26. The production line of claim 13, wherein the predetermined amount of coating material delivered to the release liner substrate material displays predetermined variable characteristics at predetermined regions of the release liner substrate material.

27. The production line of claim 26, wherein the variable characteristics comprise at least one of color, tinting, reflectivity, thickness, opaqueness, adherence, tack, anchorage of the coating material to the substrate, extractables from the cured coating material, force needed to peel a defined adhesive from the release liner at a specified angle and speed.

28. A release liner made according to the method of claim 1.

29. A release liner made according to the production line of claim 13.
